(19) United States
(12) Patent Application Publication
(10) Pub. No.: US 2023/0351277 A1
(43) Pub. Date: Nov. 2, 2023

(54) SYSTEM AND METHOD OF TRANSITION NAVIDEER FOR CAREER CHANGERS IN ADVERSE ECONOMIC ENVIRONMENTS

(71) Applicant: Anthony DePass, Freehold, NJ (US)

(72) Inventors: Anthony DePass, Freehold, NJ (US); Paris Gamble, Edmond, OK (US)

(73) Assignee: Lifestyle Learning LLC, Edmond, OK (US)

(21) Appl. No.: 17/732,770

(22) Filed: Apr. 29, 2022

(51) Int. Cl. G06Q 10/10; G06Q 10/06

(52) U.S. Cl. CPC G06Q 10/1053; G06Q 10/063112

(57) ABSTRACT

In an embodiment, a career transition system is provided. The system comprises a career transition server and a career transition application executing on the server. The system receives a listing of skills provided by an applicant device, the listing of skills associated with a user of the applicant device, the user presently associated with a first occupation with a first job classification. The system also searches an occupations database for occupations requiring at least one skill from the listing. The system also receives results from the search, the results including a plurality of occupations requiring the at least one skill. The system also extracts from the plurality of occupations at least a second occupation with a second job classification differing from the first occupation. The system sends information describing the at least second occupation to the applicant device. Job classifications are provided by at least a public agency.

### CROSS REFERENCE TO RELATED APPLICATIONS

None.

### FIELD OF THE DISCLOSURE

The present disclosure is in the field of career services. More particularly, the present disclosure provides systems and methods that receive a user's listing of skills as inputs and determines occupations and career paths based on those skills, some of said occupations and career paths that may differ markedly from the user's current or previous occupations.

### BACKGROUND

Many people have skills of which they are unaware. Some people may be aware of their skills but realize how broad these skills are and how the skills may be applicable to areas vastly different from the work they have been doing for years or even perhaps their entire adult lives. Many people feel like they are “stuck” or trapped in a particular job or career with limited or no mobility. Because of economic, social, and demographic factors beyond their control, some people view their jobs and careers as “dead end.”

The global pandemic that began in 2020 has caused significant economic and social upheaval. Many have lost their jobs, have become dislocated, and have had to relocate. People have been forced to rethink their careers and adjust professional and personal goals and expectations. They have had to develop greater insight about what they like to do and what they are good at.

Job descriptions do well in communicating responsibilities, tasks, and required and preferred credentials but don't set out skills, abilities and knowledge needed to succeed in a given position. People seeking to transition to another career may not realize that they in fact presently have the skills, abilities and knowledge to perform in a career that they had not considered might actually be a good fit. And employers do not realize that potential candidates that they might have initially disregarded could in fact make an excellent fit for their open position.

### BRIEF DESCRIPTION OF THE FIGURES

FIG. 1 is a block diagram of the system of Transition Navideer for career changers in adverse economic environments according to an embodiment of the present disclosure.

FIG. 2 through FIG. 46 are screenshot images of the graphical user interfaces provided by the system of Transition Navideer for career changers in adverse economic environments according to an embodiment of the present disclosure.

### DETAILED DESCRIPTION

Systems and methods provided herein evaluate skill sets, education levels, and other input describing potential career changers and identify careers and occupations that may differ from and be entirely unrelated to present or past occupations. Systems and methods are based on an approach that a person's skills and abilities have far wider applicability and usefulness than the person may realize. Career change possibilities may be far wider than the person can see. This may be particularly so if that person has experienced a jarring event such as an unexpected layoff or corporate downsizing or lifestyle change because of pandemic fallout.

Systems and methods process a user's input, primarily skills, search databases, and perform processing that identifies occupations the person may consider. Many identified occupations may be those that differ markedly from what the person has been doing. Skills developed in one area may be applicable to other areas that may not be immediately apparent. A user may not immediately realize or have a way of knowing that a particular skill set could be used in an entirely different career area. Such a realization may provide psychological and emotional relief to a career changer and lead that person into a direction resulting in success.

Many people have experienced the frustration and stress of trying to change direction in life. Accessing quality assistance in making a career transition, should a person decide to pursue such a transition, can be challenging. Further, it also takes a significant amount of courage to make a career transition. Attempting it on one's own could seem intimidating. Systems and methods provided herein identify key skills, abilities, and knowledge important in a current or previous position and matches different careers with the same or similar skills, abilities, and knowledge.

Transitions are an essential part of a person's journey. Without transitions and the accompanying positive experiences, people don't learn, don't grow, and cannot reach their potential. The present disclosure is directed to guiding all users to reach their true potential and simultaneously enjoy their work.

With the appropriate support and tools, dealing with a career transition is something most or all users can accomplish. The support and tools provided herein are directed to assisting parties considering career change to identify skills, match occupations and career paths, and transition to meaningful and fulfilling new employment. A career changer should not be afraid of or intimidated by change and transition. Whether a person is transitioning into the job market from military or civil service, full time studies, time off to be a parent, or just moving into a new industry, a user may be provided support by systems and methods provided herein to develop resiliency, determination, and drive.

The system provides users with information about the key things that they are doing in their current job or a previous job, so what skills were they utilizing in the current or earlier position, what abilities were they utilizing, what areas of knowledge did they develop and rely on. If a user cannot articulate what those skills, abilities, and knowledge they had relied upon and developed, the system is going to identify those areas for them. The system then uses these same important things as a bridge to determine if there are other occupations that have the same need for those skills abilities and knowledge. And further, do those other occupations consider those now-identified skills, abilities, and knowledge to be as important as the user did in the current or previous occupation.

Systems and methods provide the web/mobile career transition application that matches skills, abilities, and knowledge typical for a user's existing occupation with other occupations, some that may be very different. The application identifies alternate careers and career paths to which a user may transition. The user's perspective on his/her career possibilities may be significantly broadened. The user may be provided relief and a much-needed boost in confidence and self-esteem.

Transition Navideer may be broken out into four key modules:
1) Profile—this module contains an avatar, account settings, and dashboard.
2) Occupation Matching—defines the criteria to match a current occupation with other occupations based on skills, abilities and or knowledge.
3) Transition Exploration—identifies and displays occupations that map to the skills/abilities/knowledge criteria set in Occupation Matching. Provides additional career-related content, some proprietary, for each occupation of interest. The Transition Exploration module is leveraged under license from a Career Navideer application that comprises a suite of modules that, based on further inputs including present age and education level achieved to date, may recommend further education and other actions necessary to qualify for an occupation of interest and associated desired lifestyle. Systems and methods provided by the Career Navideer application may be used for career exploration, career readiness, career counseling, career assessment, financial literacy and financial planning.
4) My Metrics—Provides a collection of reports based on the criteria set for occupation-matching made in the application and careers explored. Some reports display proprietary data.

Persons who have been displaced from their employment by unforeseen events such as the recent pandemic or corporate downsizings may benefit from accessing systems and methods provided herein. Such persons may discover talents and abilities they were unaware that they had developed during a career they had just left or earlier. Systems and methods may help such persons match those skills and talents with opportunities that are in new fields that the person may not have known about. Persons displaced by events beyond their control may end up in a new career path they might not have otherwise been aware of.

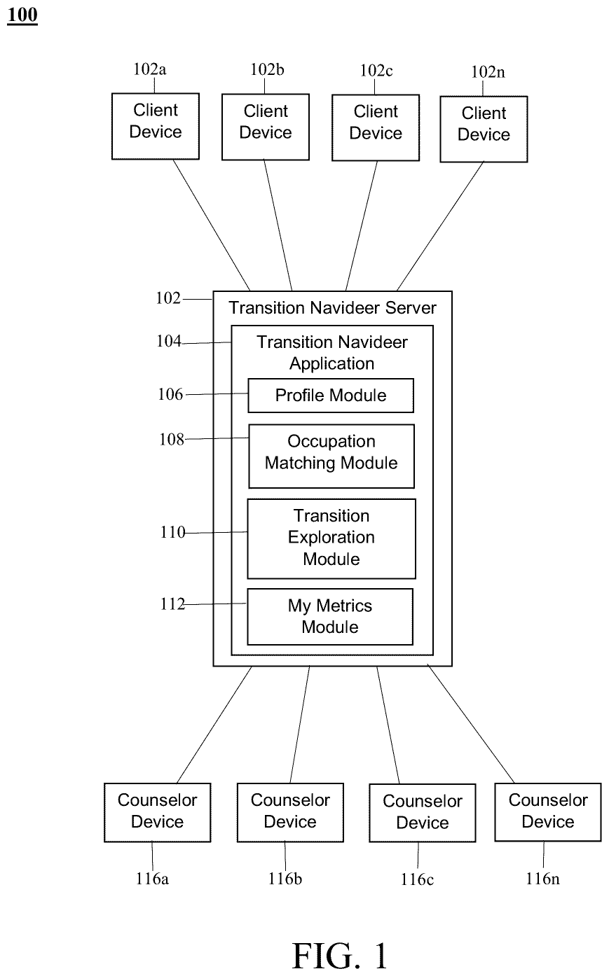

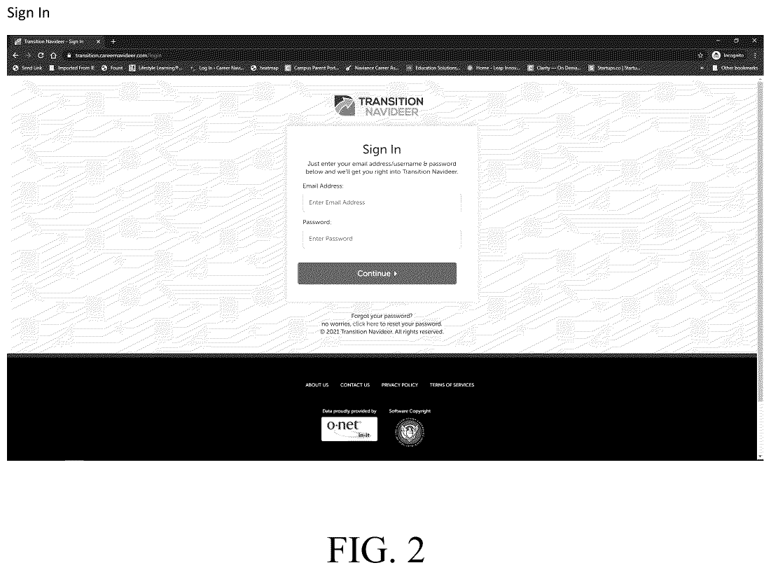

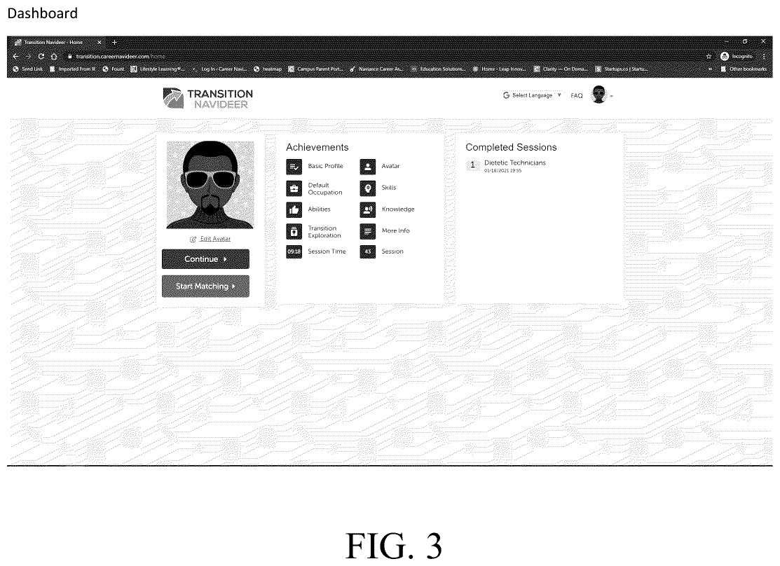

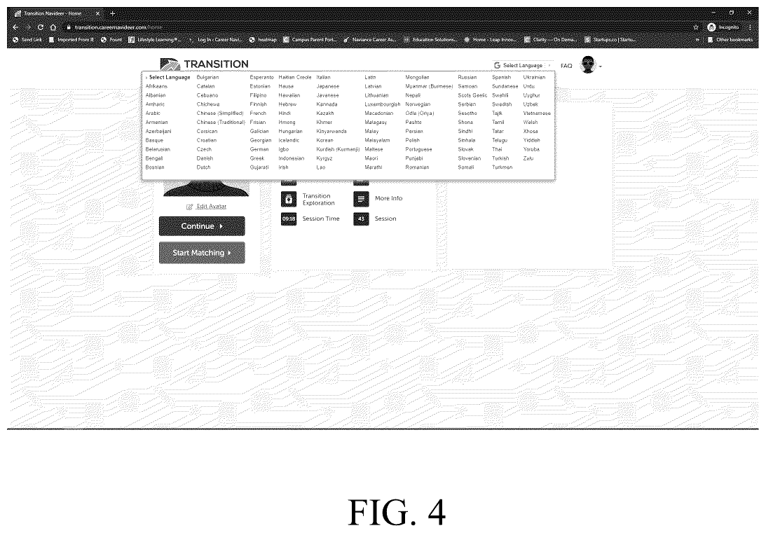

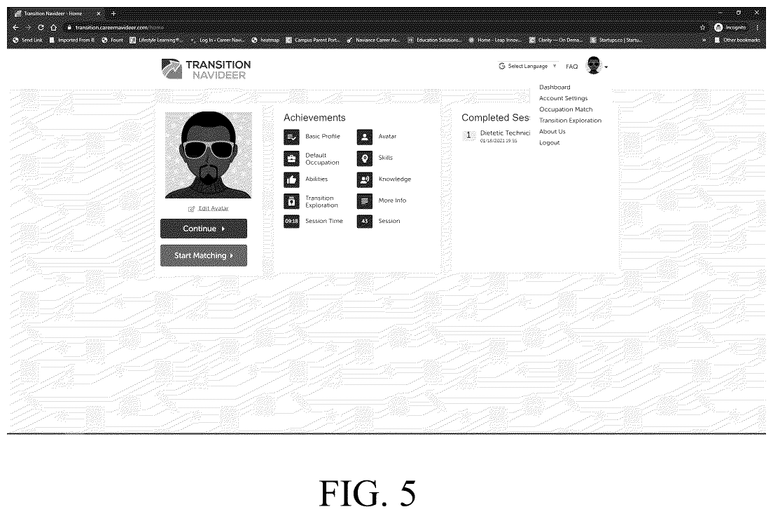

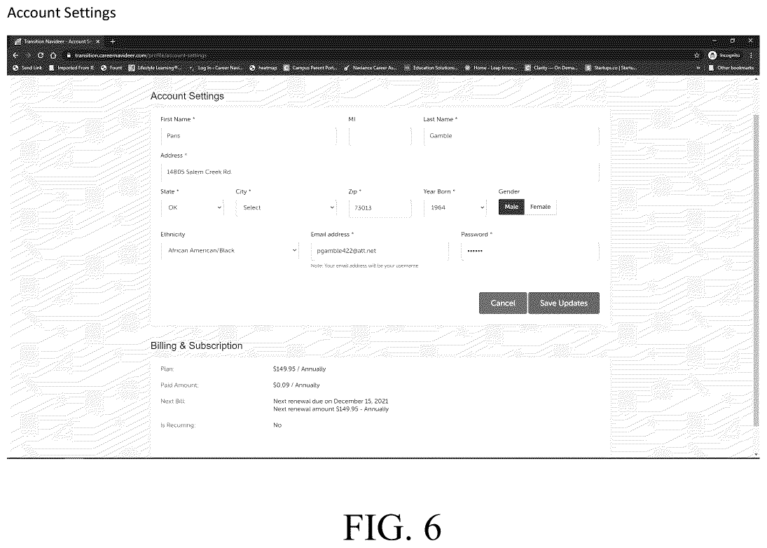

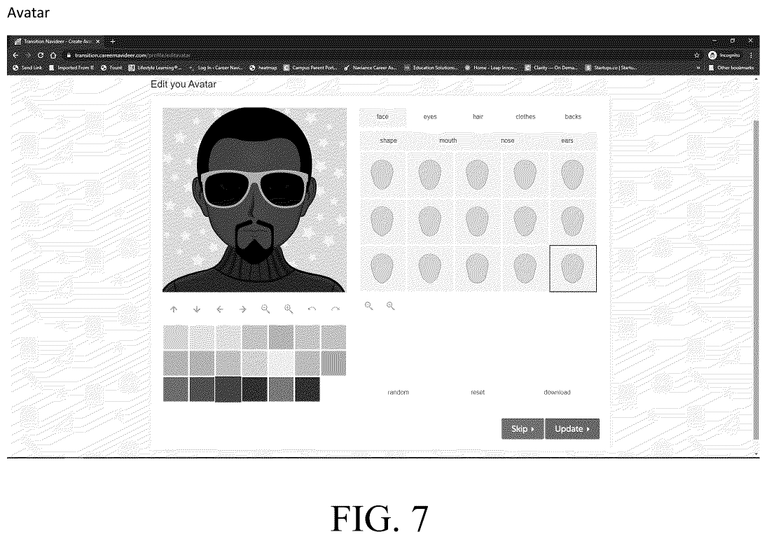

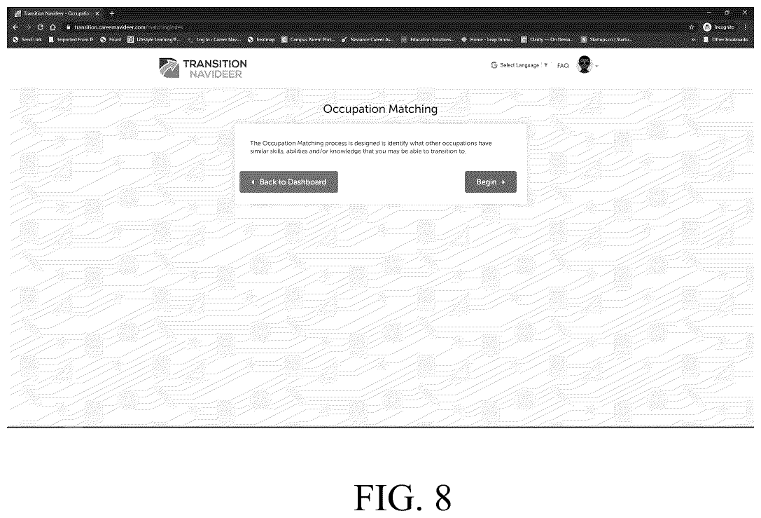

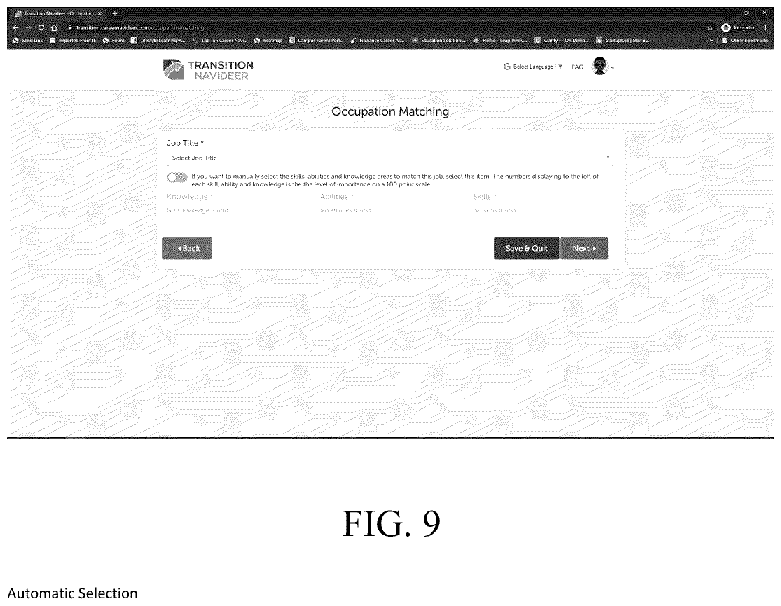

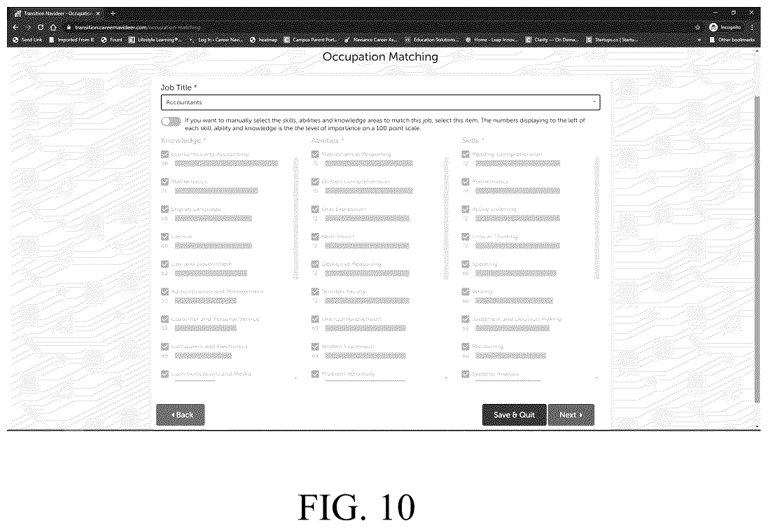

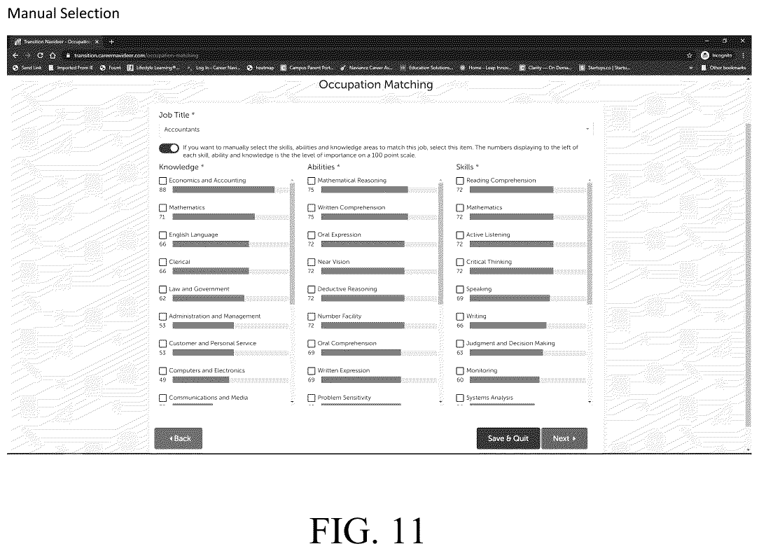

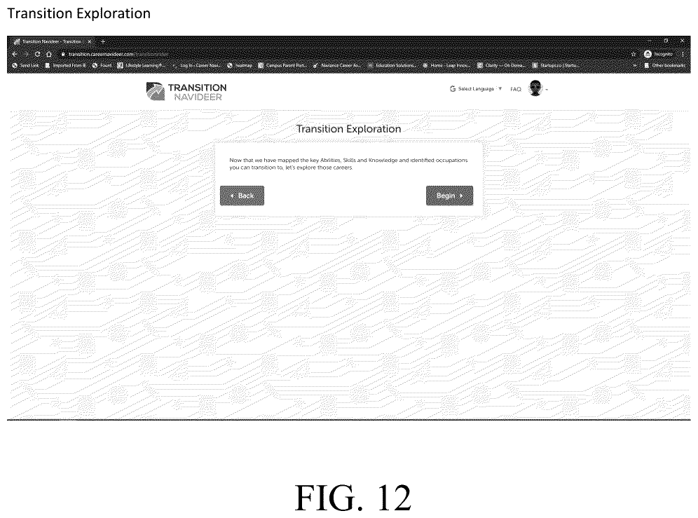

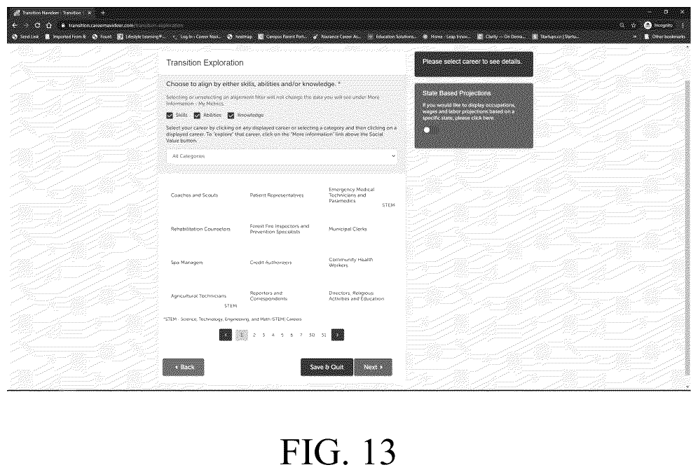

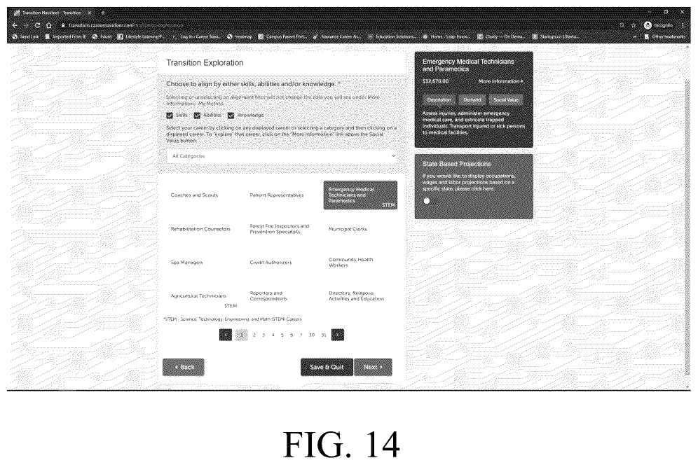

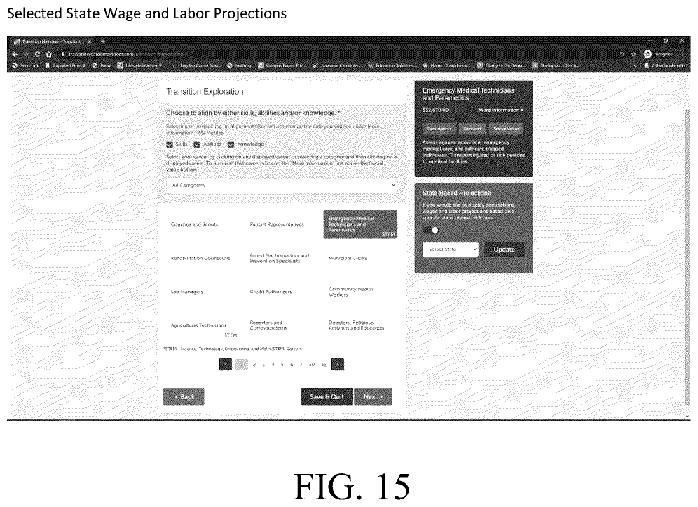

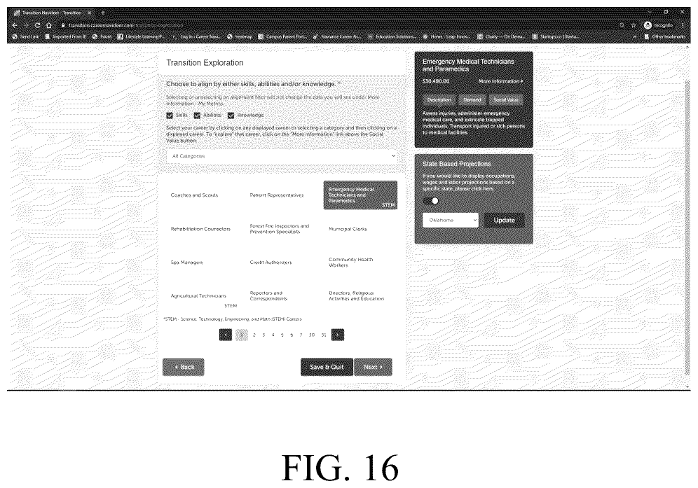

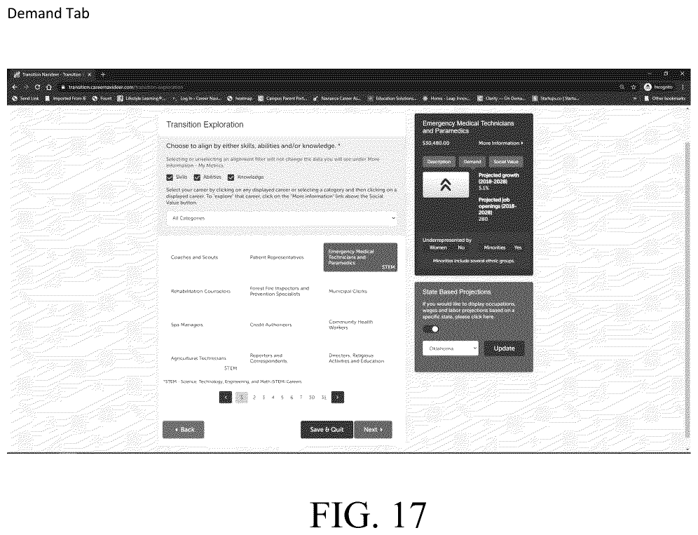

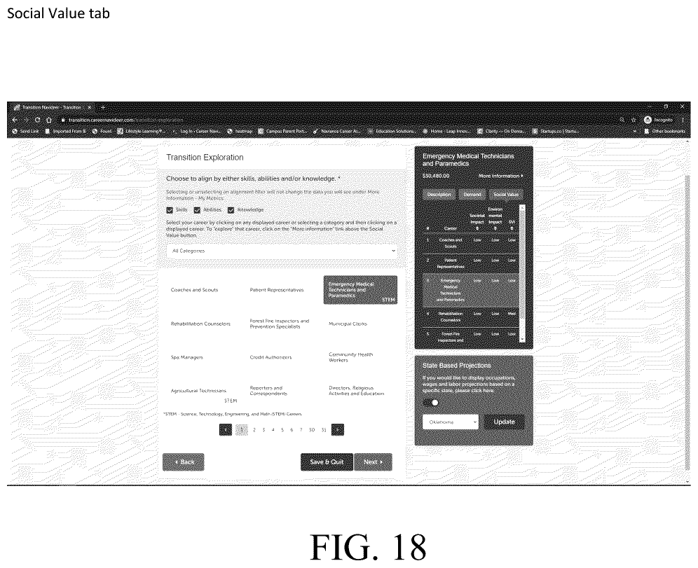

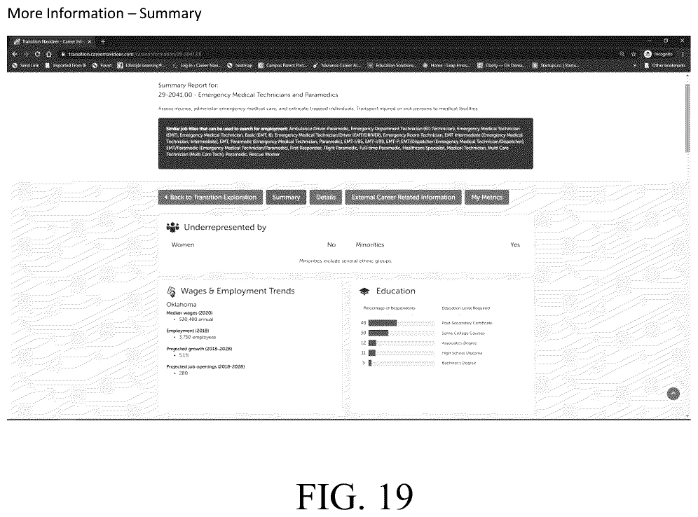

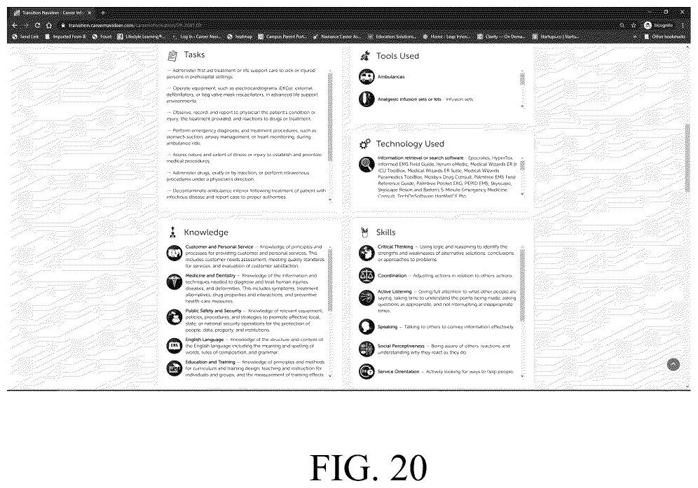

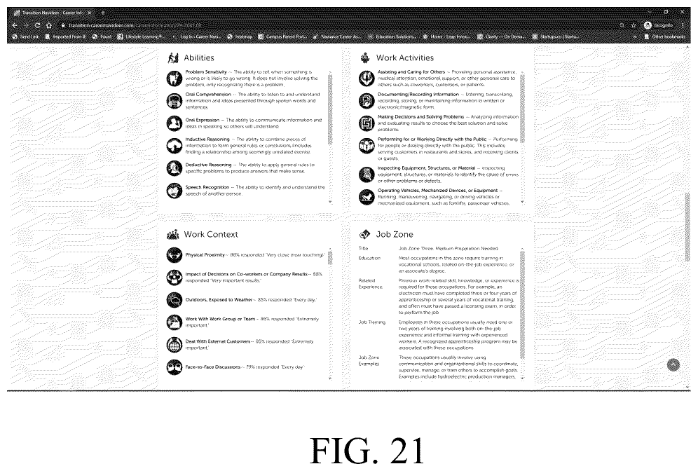

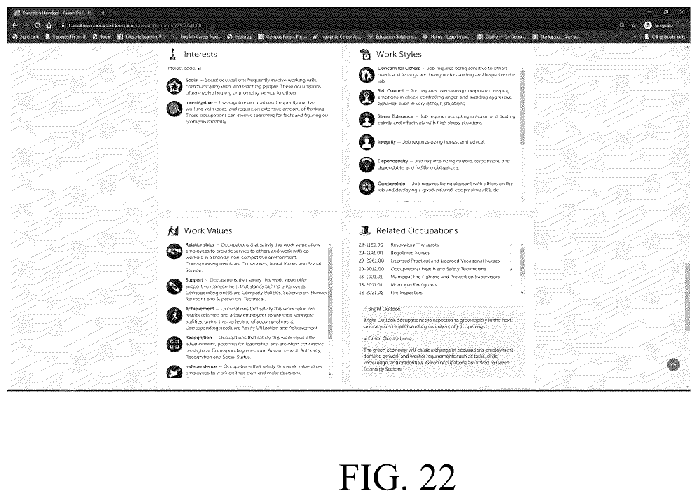

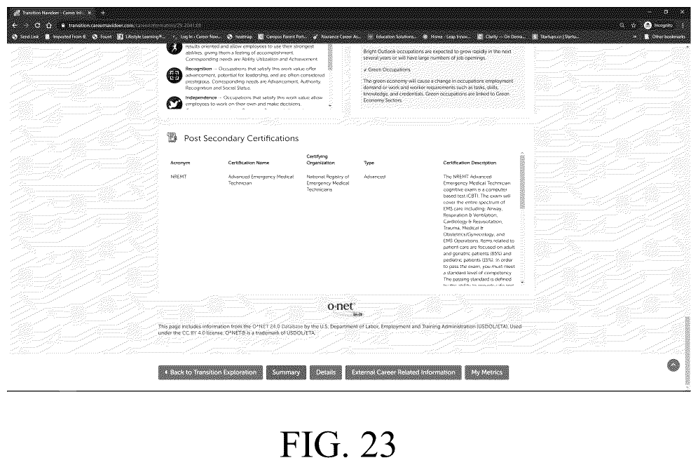

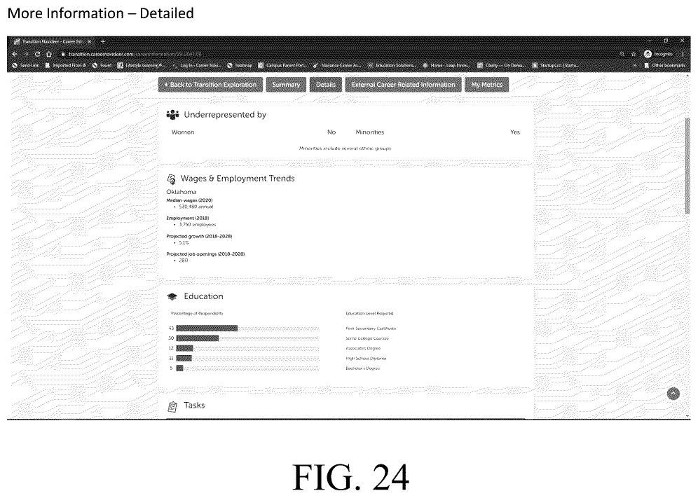

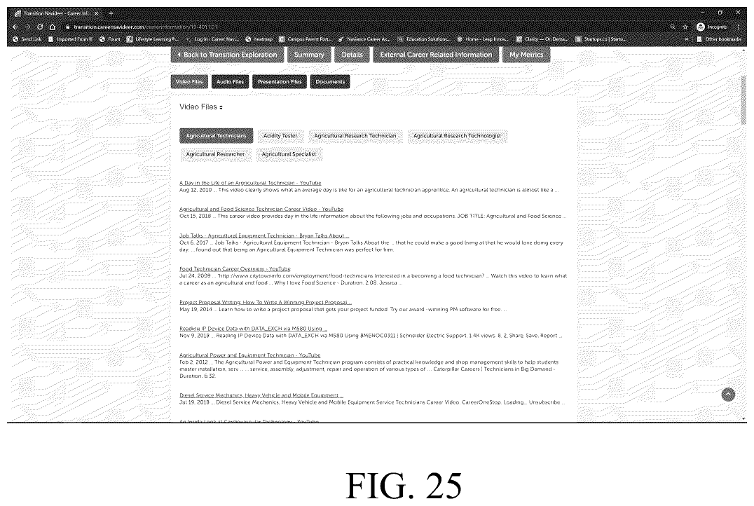

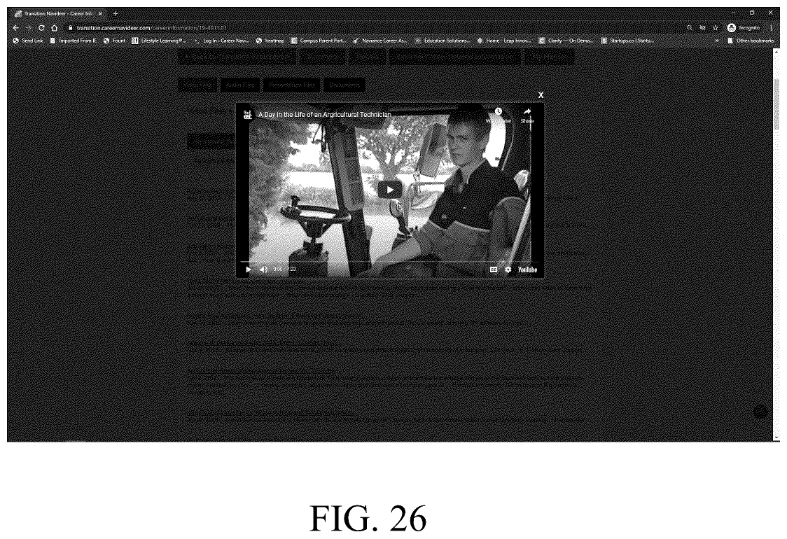

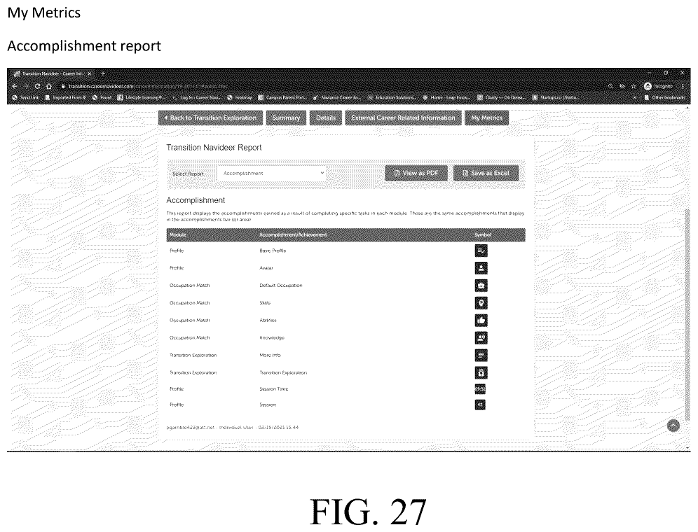

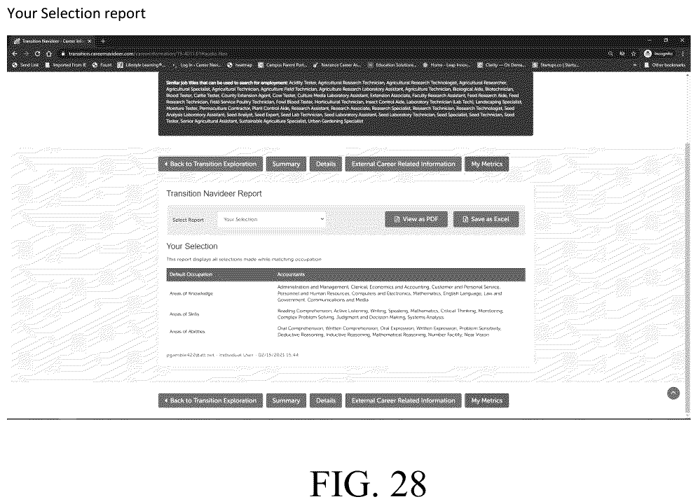

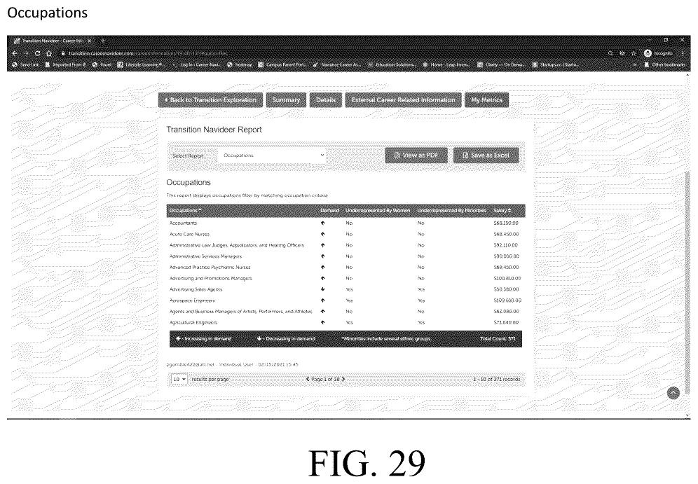

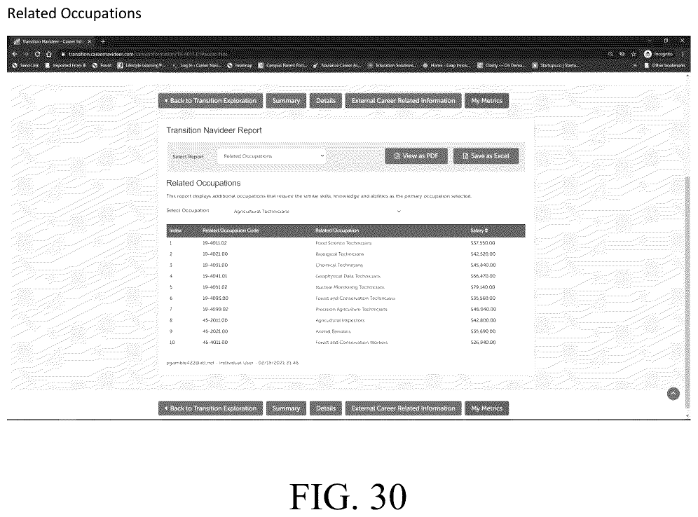

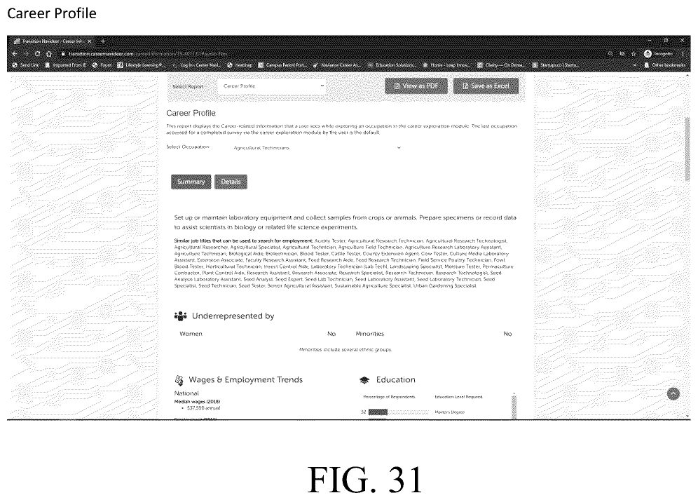

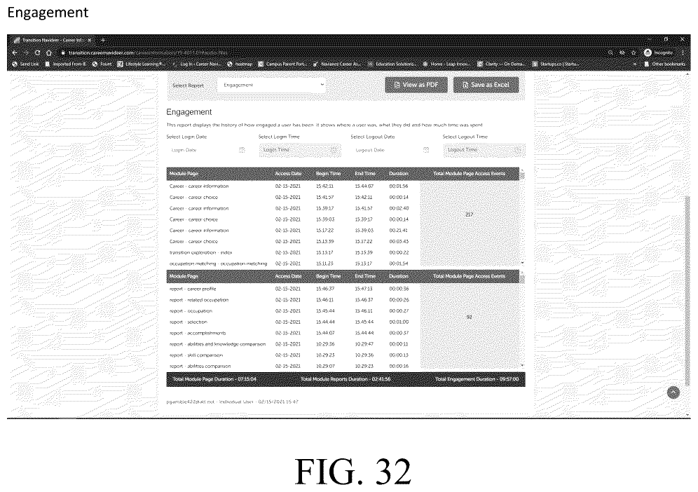

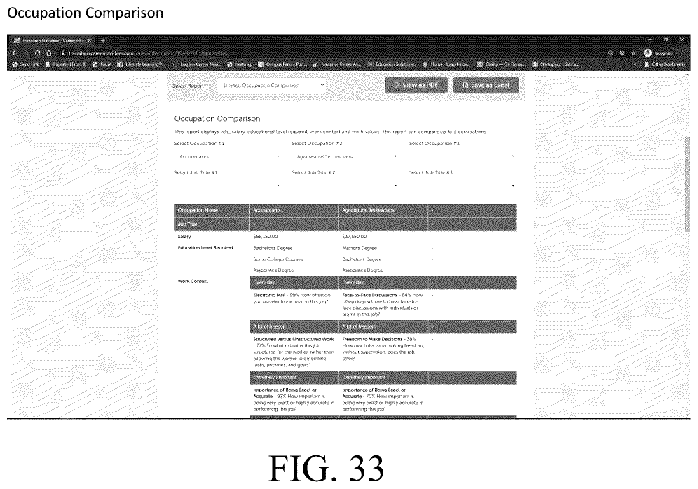

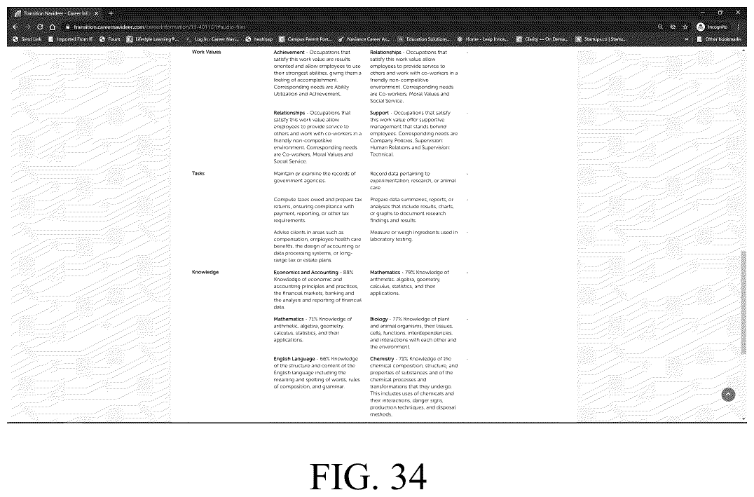

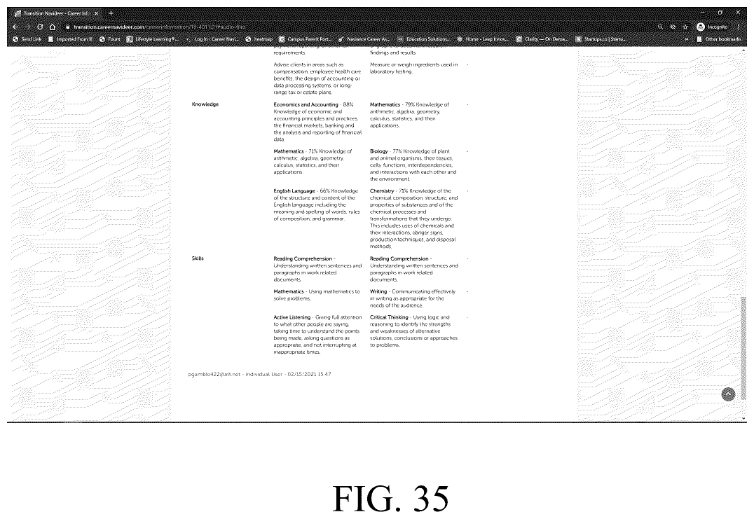

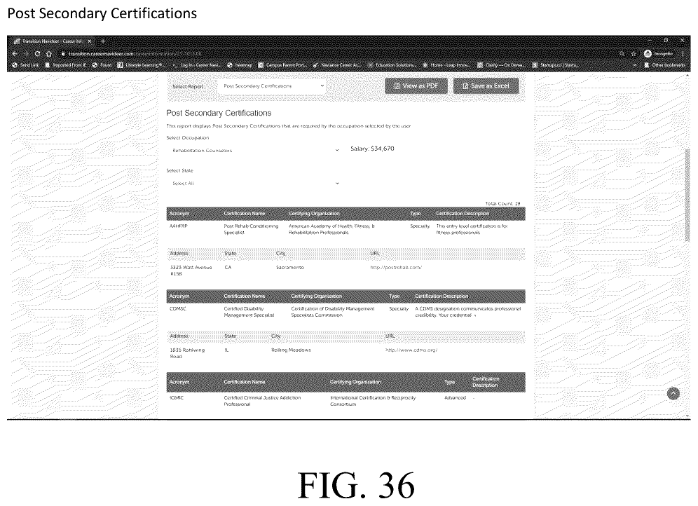

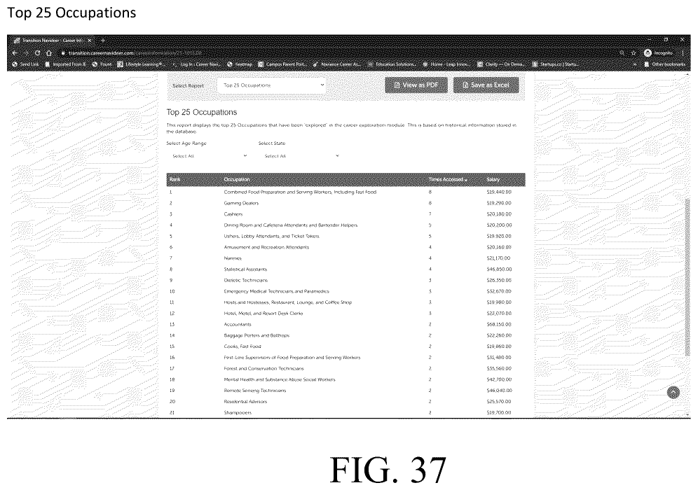

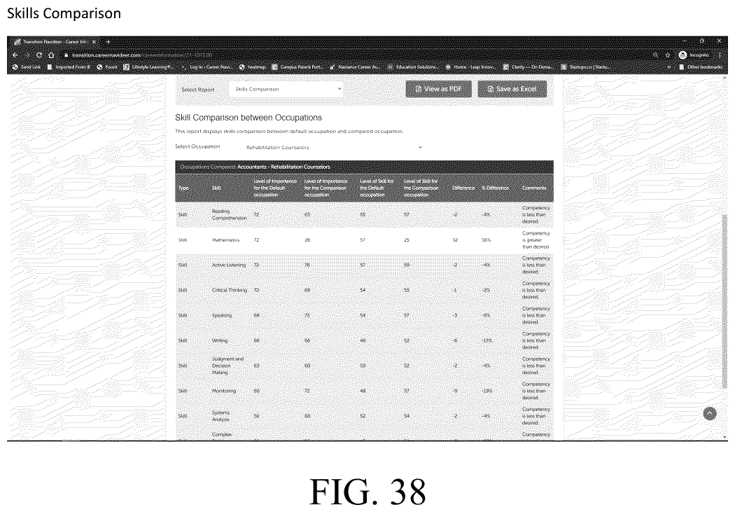

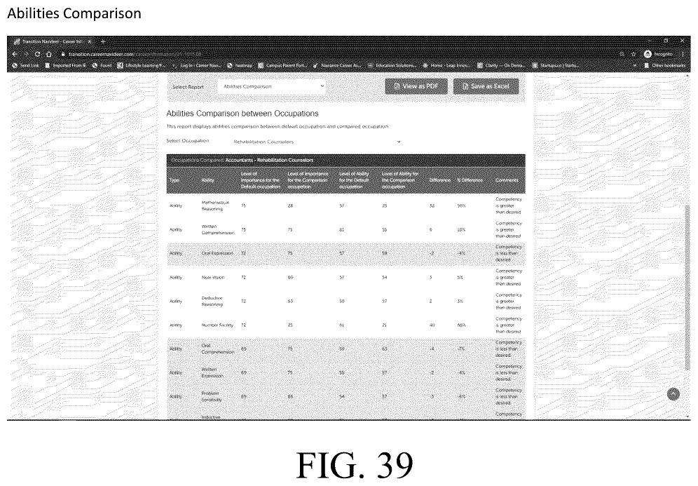

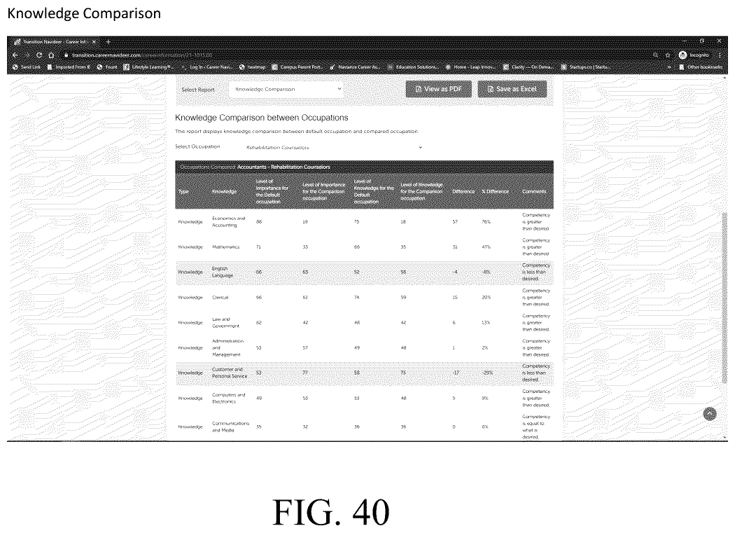

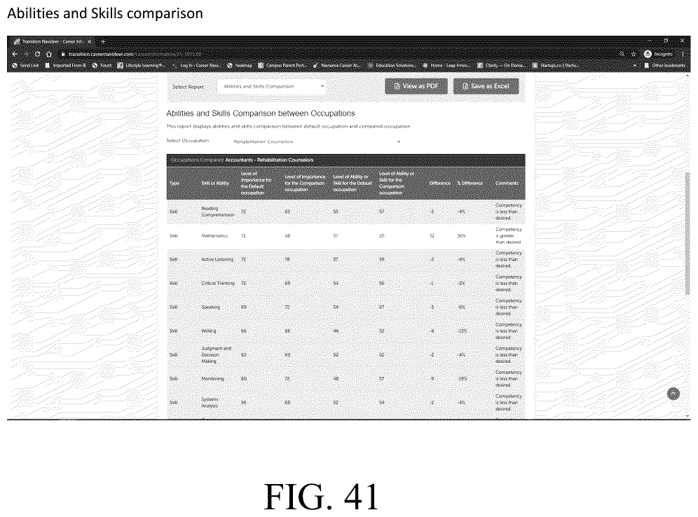

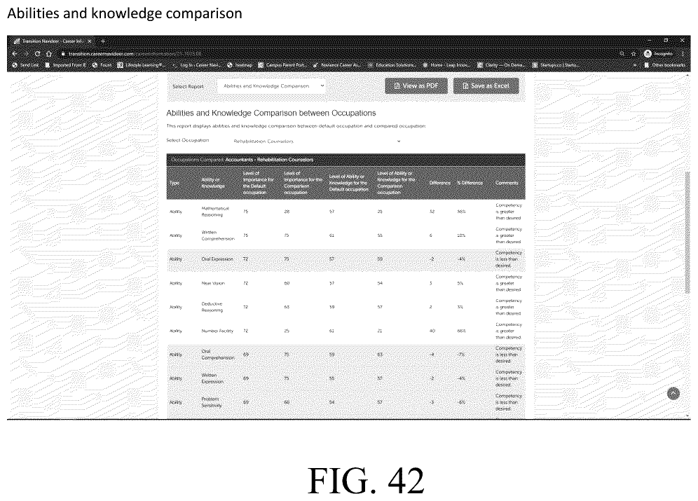

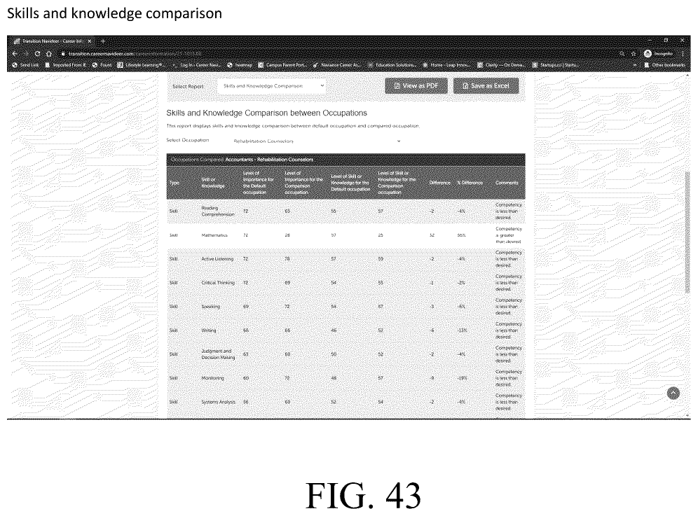

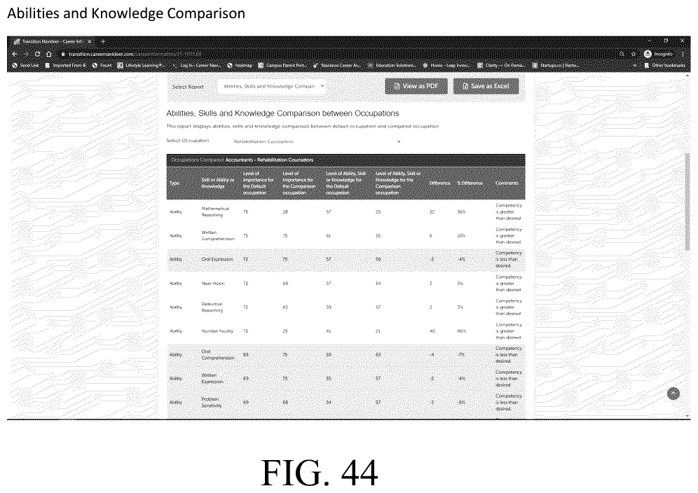

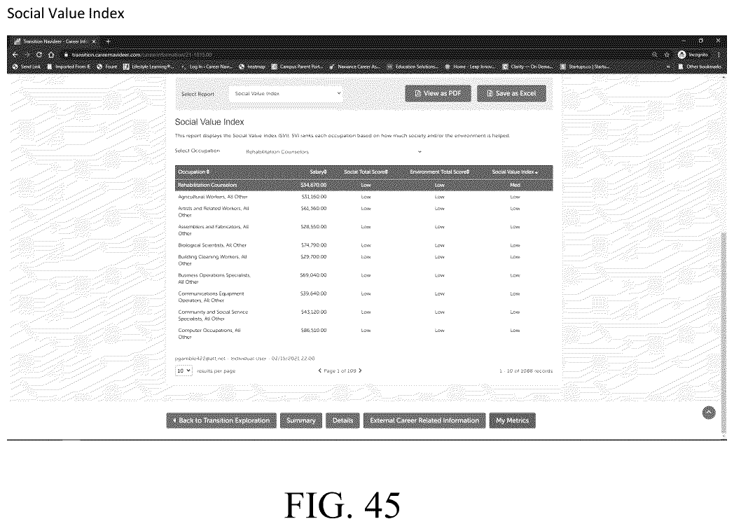

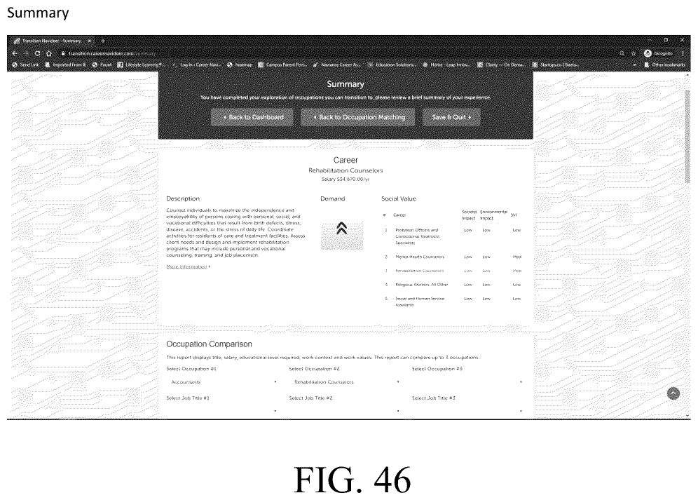

Turning to the figures, FIG. 1 is a block diagram of the system of Transition Navideer for career changers in adverse economic environments according to an embodiment of the present disclosure. A system 100 is provided, whose components and interactions are depicted in FIG. 1.

The system 100 comprises a Transition Navideer server 102 and a Transition Navideer application 104, referred to hereinafter for brevity purposes as the server 102 and the application 104, respectively. The system 100 also comprises a profile module 106, an occupation matching module 108, a transition exploration module 110, and a my metrics module 112. The system 100 also comprises client devices 114a-n and counselor devices 116a-n.

The server 102 is at least one physical computing device and internet accessible device in some embodiments that may be situated at more than one geographic location. The application 104 comprises a plurality of software modules and executes at least partially on the server 102. The profile module 106, the occupation matching module 108, the transition exploration module 110, and the my metrics module 112 are described above.

The client devices 114a-n are used by persons interested in exploring career change or expansion. Such persons may register with the server 102, submit their skills and/or submit their present occupation titles and receive output from the server 102 including suggestions of new occupations to consider.

The system 100 also comprises the counselor devices 116a-n. Systems and methods provided herein may be used by career and guidance counselors and outplacement advisors in guiding career changers, students, and persons who have been subjects of mass layoffs and corporate downsizings. Persons who may have worked in the same career for many years and have been caught up in a downsizing may seek a change of pace in their work life and do something different. Counselors using counselor devices 116a-n may interact with the server 102, enter data about displaced persons whom they are counseling, and receive valuable feedback from the system 100 about the persons' skills and possible career areas the persons might consider.

Transition Navideer is provided so organizations can also register and access data for their specific users. In situations where an employer may be laying off or otherwise terminating a large number of employees in a downsizing for example, Transition Navideer may be useful by outplacement professionals and career counselors in helping people get placed in new positions. Many people in such an unfortunate position may use the systems and methods provided herein to find new careers in areas they had not considered. By examining skills, a user may have and finding other career areas that may be unlike what the user has been doing, the user may find opportunities in fields he or she had not previously considered. Outplacement professionals, career counselors, life coaches and similar professionals may facilitate such transition for clients by availing themselves of systems and methods provided herein.

Occupations, wages, and labor projections are provided based on information associated with specific states of the US as well as on a national or federal level. Job classifications may be provided by federal, state, or local labor agencies or by private information providers. For example, the US Department of Labor may supply job classifications via the US Bureau of Labor Statistics. In embodiments, systems and methods may be applied outside the US, with job classification and other information gathered from public agencies and bodies as well as private organizations.

In an embodiment, a career transition system is provided. The system comprises a career transition server and a career transition application executing on the server. The system receives a listing of skills provided by an applicant device, the listing of skills associated with a user of the applicant device, the user presently associated with a first occupation with a first job classification. The system also searches an occupations database for occupations requiring at least one skill from the listing. The system also receives results from the search, the results including a plurality of occupations requiring the at least one skill. The system also extracts from the plurality of occupations at least a second occupation with a second job classification differing from the first occupation. The system sends information describing the at least second occupation to the applicant device. Job classifications are provided by at least a public agency. Providing the second occupation and the information suggests a possible career change from the first occupation to the second occupation. Submission of the listing of skills yields at least one occupation that differs from the first occupation by classification. The server receives inquiries from career counselor devices, the inquiries directed to determining skills transferrable between occupations unrelated to one another by job classifications. The system saves for future reference associations found between occupations unrelated by job classification but based on at least one common skill requirement. The system periodically obtains updated job classifications from public agencies and private providers of job and career classification information.

In another embodiment, a method of supporting career transition is provided. The method comprises a career transition computer receiving a first occupation title from a client device. The method also comprises the computer determining a first set of skills associated with the first occupation title. The method also comprises the computer at least partially matching the first set of skills with at least a second set of skills described at least in an occupations database, the at least second set of skills associated with at least a second occupation title differing in job classification from the first occupation title. The method also comprises the computer sending the at least second occupation title to the client device. The method also comprises the computer receiving job classification material from at least a public agency. The method also comprises the computer providing career change material to the client device along with the second occupation title. The method also comprises the computer periodically obtaining updated job classifications from public agencies and private providers of job and career classification information. The method also comprises the computer displaying occupations, wages, and labor projections based on specific states. The method also comprises receiving inquiries from career counselor devices, the inquiries directed to determining skills transferrable between occupations unrelated to one another by job classifications. The method also comprises the computer periodically sending electronic material to the career counselor devices regarding newly determined skill-related associations between occupations unrelated to one another by job classification.

In yet another embodiment, a system for assisting career change activities is provided. The system comprises a career counseling server and a career counseling application executing on the server. The system receives a first occupation title associated with a first occupation from a career counselor device. The system also identifies skills and qualifications associated with the first occupation. The system determines a first criteria of skills and qualifications for at least entry into the first occupation. The system also identifies an at least one unrelated second occupation with skills and qualifications resembling the first occupation. The application is directed to identifying the second occupation and further occupations with skills and qualifications that qualify parties associated with the second occupation and the further occupations for entry into the first occupation. The second occupation and the first occupation are identified as unrelated based at least on differences between job classifications of the second occupation and of the first occupation. Job classifications are obtained from public agencies. The career counseling server periodically updates stored job classifications obtained from the agencies. The career counseling server discovers previously unrecognized associations between unrelated occupations based on commonalities between skills and qualifications required by the unrelated occupations.

What is claimed is:

1. A career transition system, comprising:
a career transition server; and
career transition application executing on the server that:
receives a listing of skills provided by an applicant device, the listing of skills associated with a user of the applicant device, the user presently associated with a first occupation with a first job classification,
searches an occupations database for occupations requiring at least one skill from the listing,
receives results from the search, the results including a plurality of occupations requiring the at least one skill, and
extracts from the plurality of occupations at least a second occupation with a second job classification differing from the first occupation.

2. The system of claim 1, wherein the system sends information describing the at least second occupation to the applicant device.

3. The system of claim 1, wherein job classifications are provided by a public agency.

4. The system of claim 2, wherein providing the second occupation and the information suggests a possible career change from the first occupation to the second occupation.

5. The system of claim 1, wherein submission of the listing of skills yields at least one occupation that differs from the first occupation by classification

6. The system of claim 1, wherein the server receives inquiries from career counselor devices, the inquiries directed to determining skills transferrable between occupations unrelated to one another by job classifications.

7. The system of claim 1, wherein the system saves for future reference associations found between occupations unrelated by job classification but based on at least one common skill requirement.

8. The system of claim 1, wherein the system periodically obtains updated job classifications from public agencies and private providers of job and career classification information.

9. A method of supporting career transition, comprising:
a career transition computer receiving a first occupation title from a client device;
the computer determining a first set of skills associated with the first occupation title;
the computer at least partially matching the first set of skills with at least a second set of skills described at least in an occupations database, the at least second set of skills associated with at least a second occupation title differing in job classification from the first occupation title; and
the computer sending the at least second occupation title to the client device.

10. The method of claim 9, further comprising the computer receiving job classification material from at least a public agency.

11. The method of claim 9, further comprising the computer providing career change material to the client device along with the second occupation title.

12. The method of claim 9, further comprising the computer periodically obtaining updated job classifications from public agencies and private providers of job and career classification information.

13. The method of claim 9, further comprising the computer displaying occupations, wages, and labor projections based on specific states.

14. The method of claim 9, further comprising the computer periodically sending electronic material to the career counselor devices regarding newly determined skill-related associations between occupations unrelated to one another by job classification.

15. A system for assisting career change activities, comprising:
a career counseling server; and
a career counseling application executing on the server that:
receives a first occupation title associated with a first occupation from a career counselor device,
identifies skills and qualifications associated with the first occupation,
determines a first criteria of skills and qualifications for at least entry into the first occupation, and
identifies an at least one unrelated second occupation with skills and qualifications resembling the first occupation.

16. The system of claim 15, wherein the application is directed to identifying the second occupation and further occupations with skills and qualifications that qualify parties associated with the second occupation and the further occupations for entry into the first occupation.

17. The system of claim 15, wherein the second occupation and the first occupation are identified as unrelated based on differences between job classifications of the second occupation and of the first occupation.

18. The system of claim 17, wherein job classifications are obtained from public agencies.

19. The system of claim 19, wherein the career counseling server periodically updates stored job classifications obtained from the agencies.

20. The system of claim 15, wherein the career counseling server discovers previously unrecognized associations between unrelated occupations based on commonalities between skills and qualifications required by the unrelated occupations.
